(19) United States
(12) Patent Application Publication
(10) Pub. No.: US 2013/0132933 A1
(43) Pub. Date: May 23, 2013

(54) AUTOMATED COMPLIANCE TESTING DURING APPLICATION DEVELOPMENT

(71) Applicants: SADAGOPAN RAJARAM, Hyderabad (IN); Nitin Madnikar, Hyderabad (IN); Srinivas Nadimpalli, Hyderabad (IN); Pankaj Sarda, Hyderabad (IN); Neha Gurnani, Hyderabad (IN); Kedar Ajit Rudre, Hyderabad (IN)

(72) Inventors: SADAGOPAN RAJARAM, Hyderabad (IN); Nitin Madnikar, Hyderabad (IN); Srinivas Nadimpalli, Hyderabad (IN); Pankaj Sarda, Hyderabad (IN); Neha Gurnani, Hyderabad (IN); Kedar Ajit Rudre, Hyderabad (IN)

(73) Assignee: Microsoft Corporation, Redmond, WA (US)

(21) Appl. No.: 13/298,313

(22) Filed: Nov. 17, 2011

(51) Int. Cl. G06F 11/36

(52) U.S. Cl. 717/126

(57) ABSTRACT

An integrated development environment incorporates a mechanism to automatically test the execution of a software application for compliance with requirements set forth in a compliance test. The integrated development environment incorporates a compliance test tool for analyzing system data generated during execution of the software application under test. The execution of the software application is performed in a runtime environment having code markers that are used to identify the occurrence of events that are associated with the requirements of the compliance test.

### BACKGROUND

Testing is an integral part of the development of a software application. Compliance testing is performed to determine if a software application performs in accordance with required specifications. Upon a successful outcome of the compliance test, the software application may be provided with a certification status that entitles the software application with a special privilege. The compliance test may be used to verify that a software application performs reliably, does not interfere with other functions, and operates in accordance with the required specifications.

However, the software application may need to be tested several times to pass the compliance test in order to achieve the certification status. A compliance test may take several days or even weeks to process before a developer learns of the results of the compliance test. When the software application fails the compliance test, the developer may need to modify the software application and resubmit the software application for certification. The repeated attempts to pass a compliance test consume significant time and expense that may delay the deployment of the software application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An integrated development environment provides tools for a user (e.g., developer, programmer, designer, coder, etc.) to build and debug a software application. The integrated development environment provides a compliance test tool that enables a user to test the software application for compliance with a required specification during the development of the software application. In this manner, the software application may achieve certification status more readily.

The assembly file of the software application is generated in an intermediate language format. The assembly file is executed on an electronic device having a runtime environment that converts the assembly file into the machine code of the electronic device. The runtime environment inserts code markers into the application at runtime that identify points in the execution of the application that are traced. When a code marker is executed, a trace of the application is recorded. The trace data may be logged and collected for transmission to the integrated development environment to determine if the application conforms with the requirements of the compliance test.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system for automated compliance testing during application development.

FIG. 2 illustrates exemplary components used in a system for automated compliance testing.

FIG. 3 is a flow diagram illustrating an exemplary method for automated compliance testing during application development.

FIG. 4 is a block diagram illustrating an operating environment.

FIG. 5 is a block diagram illustrating an exemplary client computing device.

FIG. 6 is a block diagram illustrating an exemplary server computing device.

FIG. 7 is a block diagram illustrating an integrated development environment.

### DETAILED DESCRIPTION

Various embodiments are directed to a technology that tests an application for conformity to the rules of a compliance test while the application is under development. The application may be developed using an integrated development environment that compiles the application into an intermediate language (IL) assembly. Upon execution of the IL assembly, the runtime environment inserts code markers into the application that indicate places in the execution of the application where the application is to be traced. The trace events are then logged and collected for subsequent analysis.

The compliance test may have rules that relate to events that should occur during execution of the application in order for the application to meet the requirements of the compliance test. The compliance test may be associated with platform guidelines, such as the performance requirements associated with an operating system, standard, specification, or the like. In several embodiments, the application may be a mobile phone application that is being tested for compliance with the requirements of a mobile phone operating system.

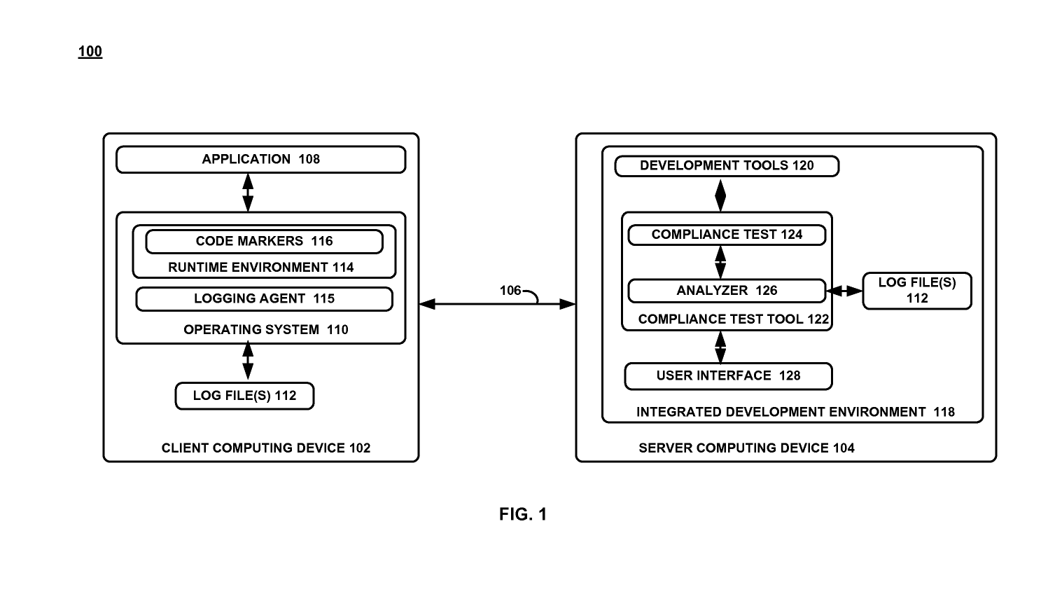

FIG. 1 illustrates a block diagram of an exemplary system for automated compliance testing during application development. The system 100 may include a client computing device 102 and a server computing device 104 communicatively coupled through a communications link 106. The client computing device 102 may be any type of electronic device capable of executing programmable instructions such as, without limitation, a mobile device, a personal digital assistant, a mobile computing device, a smart phone, a cellular telephone, a handheld computer, a tablet, and the like.

The server computing device 104 may be any type of electronic device capable of executing programmable instructions such as, without limitation, a personal digital assistant, a mobile computing device, a smart phone, a cellular telephone, a handheld computer, a server, a server array or server farm, a web server, a network server, an Internet server, a work station, a mini-computer, a mainframe computer, a supercomputer, a network appliance, a web appliance, a distributed computing system, multiprocessor systems, or combination thereof.

The communications link 106 may be any type of communications link capable of facilitating communications between the client computing device 102 and the server computing 104, utilizing any communications protocol and in any configuration, such as without limitation, a wired link, a wireless link, or combination thereof.

In several embodiments, the client computing device 102 may be a mobile phone and the server computing device 104 may be a desktop computer and the communications link 106 may be a universal serial bus that facilitates the exchange of data between the mobile phone and the desktop computer.

The client computing device 102 may include an application 108, an operating system 110, and one or more log files 112. The operating system 110 manages the resources of the client computing device 102. The operating system 110 may have a runtime environment 114 and a logging agent 115. The runtime environment may include code markers 116. A runtime environment 114 converts code in an intermediate language format into the machine code of the client computing device 102. The runtime environment 114 may have a virtual machine that includes a just-in-time compiler that performs the conversion.

The runtime environment 114 may use code markers 116 to signify the starting point of an event and/or the ending point of an event. The code markers 116 are used to measure the amount of time the application 108 takes to process an event by measuring the amount of time between the starting point and the ending point. In this manner, an event may be identified by a first code marker that signifies the start of an event and the second code marker signifies the completion of the event. The code markers may be implemented as an application programming interface (API) call that instructs the operating system to log system data at the point the code marker is executed.

The operating system may write out the system data to one or more log files 112. A logging agent 115 may be used to log system data once a code marker is detected. The logging agent 115 may be an extract, transform, and load (ETL) process that extracts data from a source, transforms the extracted data into a preferred format and load the data into a log file. For example, the Event Tracing for Windows (ETW) is an ETL process used in a Window-based operating system that enables the operating system to monitor for events and to trace system data to a log file upon the occurrence of an event. The system data may be a call stack of the threads currently executing, a dump of all system registers, and so forth. A log file 112 may include entries for each event that occurs during execution of the application 108. An entry may contain the code marker's unique identifier, a time stamp indicating the time the event occurred which is when the code marker was executed, and other system data as needed.

A server computing device 104 may include an integrated development environment 118. An integrated development environment 118 may contain development tools 120, a compliance test tool 122, and a user interface 128. The development tools 120 provide a user the tools needed to design, code, compile, test, run, edit, debug or build a program, set of programs, web sites, web applications, and web services in a computer system. The compliance test tool 122 allows a user to test an application for compliance with rules. The rules may be associated with a compliance test, a specification, a protocol, and the like. The compliance test tool 122 receives one or more log files from the client computing device 102 which are then analyzed by analyzer 126 for conformance with the rules. A user interface 128 may be provided that enables a user to interact with the integrated development environment 118 including displaying the results of the outcome of a compliance test.

Although the system 100 shown in FIG. 1 has a limited number of elements in a certain configuration, it should be appreciated that the system 100 can include more or less elements in alternate configurations. For example, the integrated development environment 118 and the application 108 may operate in the same computing device. Furthermore, the compliance test tool 122 may execute within the same process as the application in the same computing device. In these embodiments, there may not be a log file rather an in-memory data structure may be used to store the traced data for analysis. The embodiments are not limited in this manner.

In various embodiments, the system 100 described herein may comprise a computer-implemented system having multiple elements, programs, procedures, modules. As used herein, these terms are intended to refer to a computer-related entity, comprising either hardware, a combination of hardware and software, or software. For example, an element may be implemented as a process running on a processor, a hard disk drive, multiple storage drives (of optical and/or magnetic storage medium), an object, an executable, a thread of execution, a program, and/or a computer. By way of illustration, both an application running on a server and the server may be an element. One or more elements may reside within a process and/or thread of execution, and an element may be localized on one computer and/or distributed between two or more computers as desired for a given implementation. The embodiments are not limited in this manner.

The various elements of system 100 may be communicatively coupled via various types of communications medium as indicated by various lines or arrows. The elements may coordinate operations between each other. The coordination may involve the uni-directional or bi-directional exchange of information. For instance, the elements may communicate information in the form of signals communicated over the communications medium. The information may be implemented as signals allocated to various signal lines. In such allocations, each message is a signal. Further embodiments, however, may alternatively employ data messages. Such data messages may be sent various connections. Exemplary connections include parallel interfaces, serial interfaces, and bus interfaces.

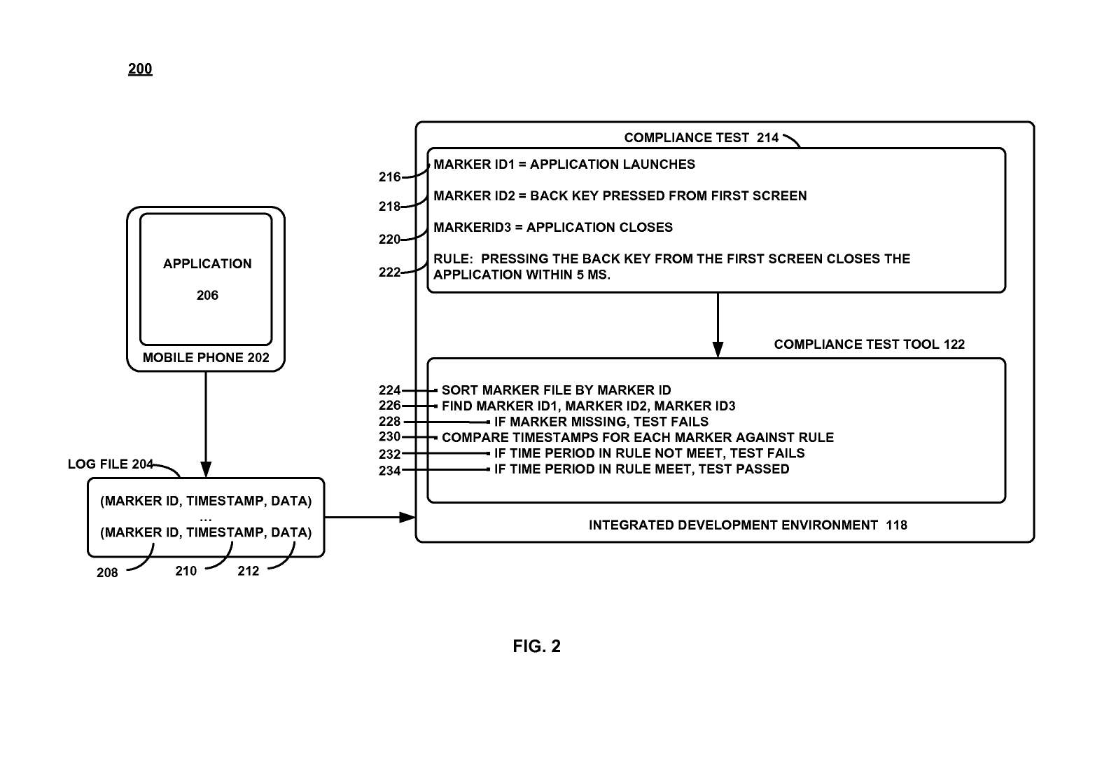

FIG. 2 illustrates an exemplary embodiment of a system 200 applied to the development of a mobile phone application 206. The integrated development environment 118 may be used to develop an application 206 for use in a mobile phone 202. The application 206 may need to obtain certification prior to being deployed on a mobile phone platform. A mobile phone platform may be associated with a particular version of a particular operating system and/or hardware configuration.

The certification may require that the application 206 pass a compliance test having a set of rules. For example, the rules may require that the application 206 launch within a certain time period from when the user clicks on a particular icon, that the application 206 deactivate within a certain time period when certain functions are performed, that the application 206 handle particular software exceptions or errors within a prescribed time period in a prescribed manner, that the application 206 perform certain functions when a back key is pressed in a prescribed condition, and so forth.

Code markers may be inserted into the application at places where certain events should occur. For example, a rule may require that when a back key stroke is pressed by a user in the first screen shown by the application, the application must close. This rule may require that the following steps be performed in sequence: first, the application launches; then, the back key stroke is pressed while the application displays the first screen; and then the application closes without error within a certain time period from when the back key stroke is pressed. In this example, an event may be the application launching and code marker, marker id1, may be used to identify the point in time when the application launches. Another event may be when the back key stroke is pressed while the first screen is displayed and code marker, marker id2, may be used to identify that point in time when the user presses the back key while on the first screen.

When a code marker is encountered during execution of the application, an entry is written into a log file. The entry may include a marker identifier, a timestamp, and other system data pertaining to the event. At the completion of the application's execution of the testing requirements, the log file is transmitted to the compliance test tool for further analysis.

Referring to FIG. 2, there is shown an exemplary system 200 having a mobile phone 202, a log file 204, and an integrated development environment 118. The mobile phone 202 has an application 206 under development that is undergoing compliance testing for deployment on the mobile phone 202. The application 206 is executed on the mobile phone 202 performing the operations required for the compliance test. During execution of the application 206, a log file 204 is generated containing trace data. An entry in the log file 204 may consist of a marker identifier (“marker id”) 208, a timestamp 210, and other system data 212 pertaining to the event associated with the marker identifier 208. The marker identifier 208 is a unique identifier of the code marker associated with an event. The timestamp 210 indicates the day and time the code marker was executed.

The compliance test 214 may include a set of rules 222 and associated code markers 216-220. As shown in FIG. 2, the rule tests whether the application closes within 5 milliseconds (ms) from the user pressing the back key stroke in the first screen. Code marker 216, identified as marker id1, marks the event when the application launches. Code marker 218, identified as marker id2, marks the event when the back key stroke is pressed from the first screen. Code marker 220, identified as marker id3, marks the event when the application closes.

The rules used in a compliance test 214 may vary. In some cases, there may be a sequence of events that need to be followed in a particular order or the events may infer a metric which is then used to determine conformance with a rule. In yet other cases, the rule may relate to a performance characteristic that is time dependent while other rules may not be time-based, such as peak memory usage. The rules are not limited in this manner.

The compliance test tool 122 analyzes the log file 204 for compliance with the rules in the compliance test 214. For example, the compliance test tool 122 may perform the following actions. The compliance test tool 122 may sort the log file 204 on the marker identifier (“marker id”) (step 224) to find the marker identifiers that correspond to rule 222 (step 226). If one of the marker identifiers is missing, then the application fails the compliance test since the event did not occur as required (step 228). Otherwise, the compliance test tool 122 compares the timestamps in each entry associated with the required markers, (e.g., marker id1-marker id3) to ascertain whether or not the application closed within the prescribed time period from when the back key stroke was pressed in the first screen (step 230). If the timestamps indicate that the event did not occur within the time period prescribed in the rule, then the compliance test fails (step 232). Otherwise, if the timestamps indicate that the event occurred within the time period prescribed in the rule, the compliance test passes (step 234).

Attention now turns to embodiments of exemplary methods for automated compliance testing during application development. It may be appreciated that the exemplary methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

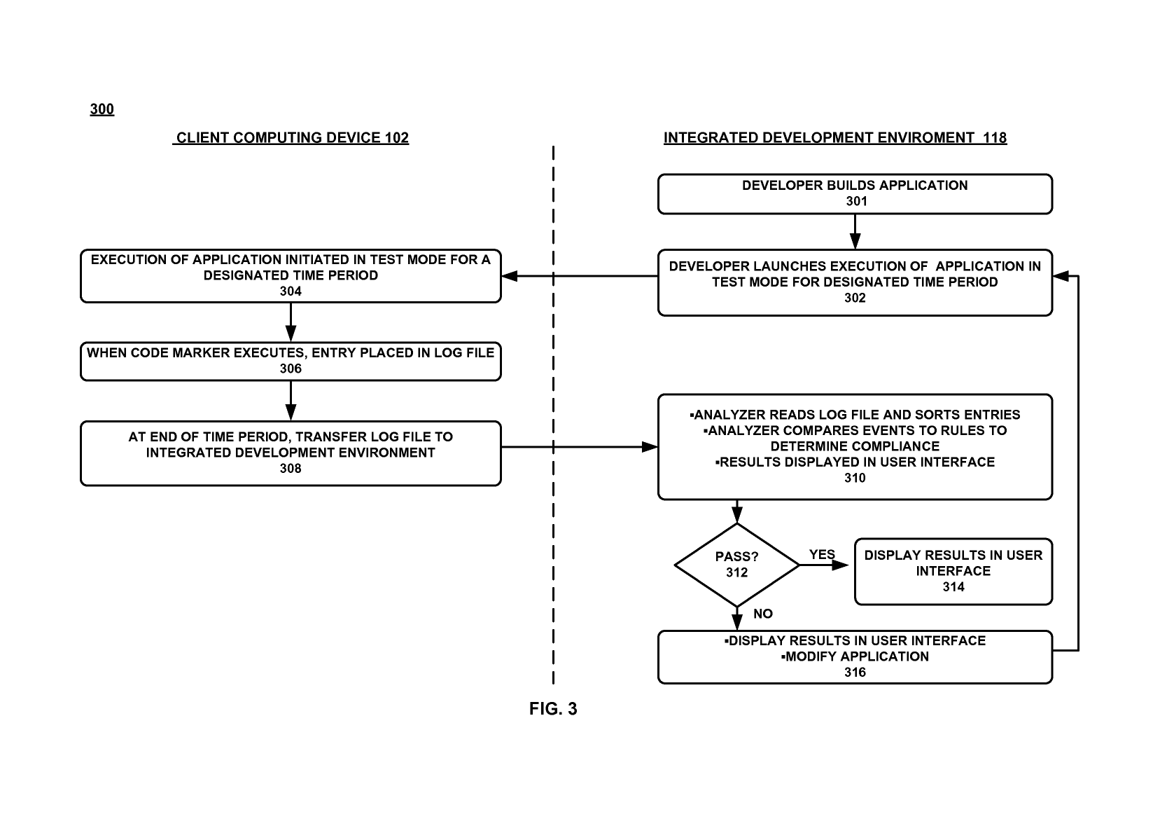

FIG. 3 illustrates a flow diagram of an exemplary method for automated compliance testing during program execution. It should be noted that the method 300 may be representative of some or all of the operations executed by one or more embodiments described herein and that the method can include more or less operations than that which is described in FIG. 3.

A developer may utilize an integrated development environment 118 to develop an application 108 for use on a client computing device 102 (block 301). The client computing device 102 may be a remote device distinct from the server computing device. The client computing device 102 may communicate with the server computing device 104 through a communications link 106. The developer may initiate an instruction from the integrated development environment 118 to launch execution of the application on the client computing device 102 in test mode to perform a compliance test (block 302). The instruction from the integrated development environment 118 is received by the client computing device 102 and the application executes in test mode for a designated time period (block 304).

As the application executes performing the operations required by the compliance test, code markers may be executed thereby logging an entry in the log file (block 306). At the end of the time period for the compliance test, the log file is transferred from the client computing device 102 to the integrated development environment 118 (block 308). The analyzer 126 reads the log file and sorts the entries (block 310). The entries may be sorted by marker identifier and then on timestamp in order for the analyzer to find the entries in the log file more readily (block 310). The analyzer 126 compares the marker identifiers and timestamps against the rules in order to determine if each rule has been met (block 310). If all the rules have been meet, then the compliance test is deemed to have been passed (block 312—yes) and the developer may be notified through the user interface that the application passed the compliance test (block 314).

In the event the rules in the compliance test have not been met (block 312—no), the results may be displayed to the developer through the user interface (block 316). Optionally, the developer may modify the application and resubmit the application for additional testing (block 314).

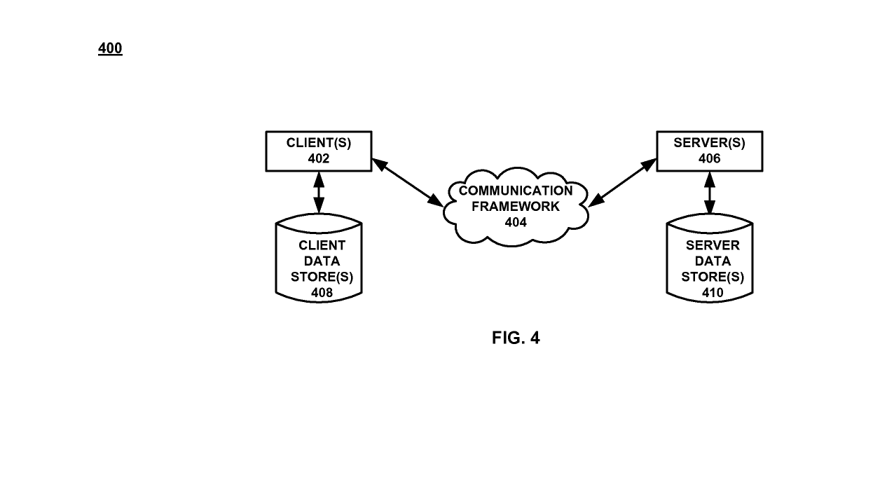

Attention now turns to a discussion of an exemplary operating environment. FIG. 4 illustrates an operating environment 400. It should be noted that the operating environment 400 is exemplary and is not intended to suggest any limitation as to the functionality of the embodiments. The embodiment may be applied to an operating environment 400 having one or more client(s) 402 in communication through a communications framework 404 with one or more server(s) 406. The operating environment 400 may be configured in a network environment, a distributed environment, a multiprocessor environment, or as a stand-alone computing device having access to remote or local storage devices.

A client 402 may be embodied as a hardware device, a software module, or as a combination thereof. Examples of such hardware devices may include, but are not limited to, a computer (e.g., server, personal computer, laptop, tablet, etc.), a mobile phone, a personal digital assistant, or any type of computing device, and the like. A client 402 may also be embodied as a software module having instructions that execute in a single execution path, multiple concurrent execution paths (e.g., thread, process, etc.), or in any other manner

A server 406 may be embodied as a hardware device, a software module, or as a combination thereof. Examples of such hardware devices may include, but are not limited to, a computer (e.g., server, personal computer, laptop, tablet, etc.), a mobile phone, a personal digital assistant, or any type of computing device, and the like. A server 406 may also be embodied as a software module having instructions that execute in a single execution path, multiple concurrent execution paths (e.g., thread, process, etc.), or in any other manner

The communications framework 404 facilitates communications between the client 402 and the server 406. The communications framework 404 may embody any type of communications medium, such as wired or wireless networks, utilizing any communication protocol. Each client(s) 402 may be coupled to one or more client data store(s) 408 that store information local to the client 402. Each server(s) 406 may be coupled to one or more server data store(s) 410 that store information local to the server 406.

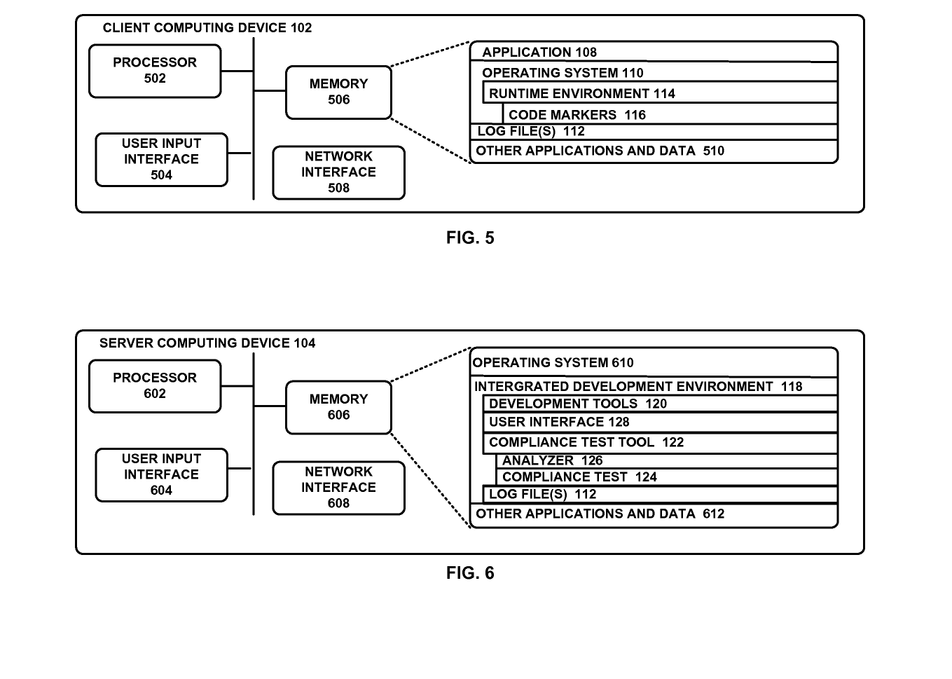

FIG. 5 illustrates a block diagram of an exemplary client computing device 102. The client computing device 102 may have a processor 502, user input interface 504, a memory 506, and network interface 508. The processor 502 may be any commercially available processor and may include dual microprocessors and multi-processor architectures. The user input interface 504 facilitates communications between the client computing device 102 and input devices, such as a keyboard, mouse, etc. The network interface 508 facilitates wired or wireless communications between the client computing device 102 and a communications framework.

The memory 506 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 506 may also include one or more external storage devices or remotely located storage devices. The memory 506 may contain instructions and data as follows:
an application 108;
an operating system 110 having a runtime environment 114, the runtime environment having code markers 116;
one or more log files 112; and
various other applications and data 510.

FIG. 6 illustrates a block diagram of an exemplary server computing device 104. The server computing device 104 may have a processor 602, a user input interface 604, a memory 606, and network interface 608. The processor 602 may be any commercially available processor and may include dual microprocessors and multi-processor architectures. The user input interface 604 facilitates communications between the server computing device 104 and input devices, such as a keyboard, mouse, etc. The network interface 608 facilitates wired or wireless communications between the server computing device 104 and a communications framework.

The memory 606 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 606 may also include one or more external storage devices or remotely located storage devices. The memory 606 may contain instructions and data as follows:
an operating system 610;
an integrated development environment 118 having development tools 120, a user interface 128, and a compliance test tool 122. The compliance test tool 122 having an analyzer 126 and a compliance test 124;
one or more log file(s) 112; and
various other applications and data 612.

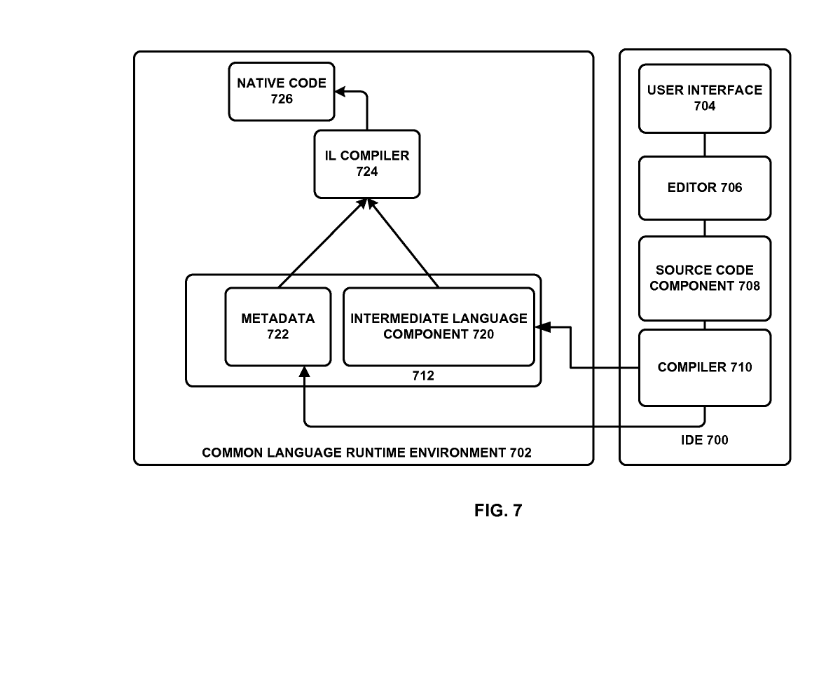

FIG. 7 illustrates an integrated development environment 700 and Common Language Runtime Environment 702. An IDE 700 may allow a user (e.g., developer, programmer, designer, coder, etc.) to design, code, compile, test, run, edit, debug or build a program, set of programs, web sites, web applications, and web services in a computer system. Software programs can include source code (component 708), created in one or more source code languages (e.g., Visual Basic, Visual J#, C++. C#, J#, Java Script, APL, COBOL, Pascal, Eiffel, Haskell, ML, Oberon, Perl, Python, Scheme, Smalltalk and the like). The IDE 700 may provide a native code development environment or may provide a managed code development that runs on a virtual machine or may provide a combination thereof.

The IDE 700 may provide a managed code development environment using the .NET framework. An intermediate language component 720 may be created from the source code component 708 and the native code component 726 using a language specific source compiler 710 and the native code component 726 (e.g., machine executable instructions) is created from the intermediate language component 720 using the intermediate language (IL) compiler 724 (e.g. just-in-time (JIT) compiler), when the application is executed. That is, when an intermediate language application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 704 and a source code editor 706 in the IDE 700. Thereafter, the source code component 708 can be compiled via a source compiler 710, whereby an intermediate language representation of the program may be created, such as assembly 712. The assembly 712 may comprise the intermediate language component 720 and metadata 722.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

Some embodiments may comprise a storage medium to store instructions or logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as programs, procedures, module, applications, code segments, program stacks, middleware, firmware, methods, routines, and so on. In an embodiment, for example, a computer-readable storage medium may store executable computer program instructions that, when executed by a processor, cause the processor to perform methods and/or operations in accordance with the described embodiments. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

What is claimed:

1. A computer-implemented method, comprising:
executing an application subject to a compliance test, the compliance test used to obtain a certification status for the application to operate on a platform;
monitoring the application for events occurring during execution of the application, the events associated with the compliance test; and
analyzing the events for conformity with the compliance test.

2. The computer-implemented method of claim 1, further comprising:
prior to executing an application subject to a compliance test, developing the application in an integrated development environment.

3. The computer-implemented method of claim 2, wherein the developing step is performed using an integrated development environment executing in a first device, the executing step is performed in a second device remotely coupled to the first device, and the analyzing step is performed in the first device, the first device differs from the second device.

4. The computer-implemented method of claim 3, wherein the second device is a mobile device.

5. The computer-implemented method of claim 2, wherein the developing step is performed using an integrated development environment executing in a first device, the executing step is performed in a second device remotely coupled to the first device, and the analyzing step is performed in the second device, the first device differs from the second device.

6. The computer-implemented method of claim 2, wherein the developing step is performed in a first device, the executing step is performed in the first device, and the analyzing step is performed in the first device.

7. The computer-implemented method of claim 5, wherein the second device is a mobile device.

8. The computer-implemented method of claim 1, further comprising:
identifying an event by inserting code markers in the application during runtime; and
upon execution of an event, recording a trace of execution of the application.

9. The computer-implemented method of claim 8, further comprising:
analyzing the recording of a trace of execution of the application for conformance with the compliance test.

10. A computer-readable storage medium storing thereon processor-executable instructions, comprising:
instructions, that when executed on a processor, executes an application subject to a compliance test, the compliance test used to obtain a certification status for the application to operate on a platform;
instructions, that when executed on a processor, inserts code markers into the application during runtime, the code markers used to monitor for occurrence of events occurring during execution of the application; and
instructions, that when executed on a processor, records system data upon occurrence of the events raised by the code markers during execution of the application.

11. The computer-readable storage medium of claim 10, further comprising:
instructions, that when executed on a processor, analyzes the system data to determine conformity with the compliance test.

12. The computer-readable storage medium of claim 10, further comprising:
instructions, that when executed on a processor, transmits the system data to a remote device for analysis.

13. The computer-readable storage medium of claim 10, wherein the application executes on a mobile phone device.

14. The computer-readable storage medium of claim 11, further comprising:
instructions, that when executed on a processor, develops the application prior to executing the application; and
instructions, that when executed on a processor, edits the application after the application fails to conform to the compliance test.

15. A computer-readable storage medium storing therein processor-executable instructions, comprising:
an integrated development environment, having instructions that when executed on a processor, monitors execution of an application for conformance with a compliance test through an event trace and determines conformity with the compliance test, the compliance test used to obtain a certification status for the application to operate on a platform, the event trace containing system data pertaining to events occurring during execution of the application, the application executes outside of the integrated development environment.

16. The computer-readable storage medium of claim 15, wherein the integrated development environment, has instructions that when executed on a processor, analyzes the event trace to determine conformance with the compliance test.

17. The computer-readable storage medium of claim 15, the integrated development environment having tools that facilitate development of the application to adhere to the compliance test.

18. The computer-readable storage medium of claim 15, wherein the integrated development environment executes in a first device and the application executes in a second device, the first device remotely coupled to the second device.

19. The computer-readable storage medium of claim 17, wherein the second device is a mobile phone.

20. The computer-readable storage medium of claim 15, wherein the integrated development environment executes in a same device as the application.
